(19) United States
(12) Patent Application Publication
(10) Pub. No.: US 2011/0131579 A1
(43) Pub. Date: Jun. 2, 2011

(54) BATCH JOB MULTIPLEX PROCESSING METHOD

(75) Inventors: TETSUFUMI TSUKAMOTO, Nagareyama (JP); Hideyuki Kato, Machida (JP); Hideki Ishiai, Kawasaki (JP); Yuki Tateishi, Kawasaki (JP); Takahiro Kyuma, Tokyo (JP); Yozo Ito, Tokyo (JP); Takeshi Fujisawa, Funabashi (JP); Masaaki Hosouchi, Zama (JP); Kazuhiko Watanabe, Yokohama (JP)

(73) Assignee: Hitachi, Ltd.

(21) Appl. No.: 12/841,961

(22) Filed: Jul. 22, 2010

(30) Foreign Application Priority Data
Jul. 24, 2009 (JP) 2009-172674

(51) Int. Cl. G06F 9/46

(52) U.S. Cl. 718/101

(57) ABSTRACT

A batch job multiplex processing method which solves the problem that a system which performs multiplex processing including parallel processing on plural nodes cannot cope with a sudden increase in the volume of data to be batch-processed using a predetermined value of multiplicity, for example, in securities trading in which the number of transactions may suddenly increase on a particular day. The method dynamically determines the value of multiplicity of processing including parallel processing in execution of a batch job on plural nodes. More specifically, in the method, multiplicity is determined depending on the node status (node performance and workload) and the status of an input file for the batch job.

The present application claims priority from Japanese application serial No. 2009-172674, filed on (Jul. 24, 2009), the content of which is hereby incorporated by reference into this application.

### FIELD OF THE INVENTION

The present invention relates to a technique for effective batch processing. More particularly, it relates to a technique which determines the optimum processing multiplicity in parallel execution of batch jobs using plural nodes for high speed batch processing of large volumes of account data.

### BACKGROUND OF THE INVENTION

JP-A-2008-226181 proposes a technique for execution of batch jobs. In this technique, script data about job nets which defines the order of execution of jobs is received and a request for allocation of resource nodes for execution of the job nets is issued on a per-job-net basis in accordance with the script data so that resource nodes are allocated to each job net in response to the allocation request.

### SUMMARY OF THE INVENTION

In batch processing, there are cases where the volume of data to be processed suddenly increases. For example, in the securities industry, it is necessary to cope with various situations: for example, all accounts for month-end reinvestment of investment trusts must be processed on a particular day; the number of stock transactions suddenly increases in some economic climate; and when there are many initial public offerings (IPO) in a short time, an increasing number of transactions must be dealt with, resulting in a longer batch processing time. Consequently, the volume of batch processing jobs largely varies day by day and sometimes a longer time must be taken for batch processing. This is likely to lead to a delay in the start of next day's online service and a shorter online service time for customers. Also, such lengthened batch processing may affect processing time for another job which is executed on the same node simultaneously, again resulting in a delay in the start of online service related to that job. Therefore, daily batch processing time should be constant even when the volume of data to be processed varies from day to day.

In order to address the above problem, the present invention dynamically determines multiplicity of processing including parallel processing in execution of a batch job on plural nodes. More specifically, the invention provides a system which flexibly determines execution multiplicity and execution nodes to shorten batch processing time by effective utilization of resources. Processing time can be made (almost) constant regardless of the number of batch jobs by batch processing in a scale-out manner on a particular day when the number of batch jobs increases. This eliminates the possibility that a long time is taken to batch-process large volumes of data on a particular day and a delay in the start of next-day online service occurs.

There are many types of batch processes: some batch processes require CPU resources and others require disk resources. In the present invention, the user can specify parameters for each job group and choose one of two methods for determining execution multiplicity so that the user can determine execution multiplicity by the more suitable method for the type of jobs and the location of input data to shorten batch processing time more effectively.

According to the present invention, batch processing is performed more efficiently.

### BRIEF DESCRIPTION OF THE DRAWINGS

FIG. 1 shows a system configuration according to a preferred embodiment of the invention;

FIG. 2 shows the content of a node management table on a job management node;

FIG. 3 shows the content of a sub job management table on the job management node;

FIG. 4 shows the content of a job management table on the job management node;

FIG. 5 shows the content of a data location information table on the job management node;

FIG. 6 shows the content of a job group execution condition table on the job management node;

FIG. 7 shows the content of a job group execution node group table on the job management node;

FIG. 8 shows a job execution flow according to the preferred embodiment of the invention;

FIG. 9 shows the first half of a flow of multiplicity determination by a sub job synchronization method;

FIG. 10 shows the second half of the flow of multiplicity determination by the sub job synchronization method; and

FIG. 11 shows a flow of multiplicity determination by a sub job parallel method.

### DETAILED DESCRIPTION OF THE PREFERRED EMBODIMENTS

Next, the preferred embodiment of the present invention will be described in detail referring to the accompanying drawings. The embodiment explained below is illustrative and the invention is not limited thereto.

For the sake of simplicity, the explanation given below is based on the assumption that the number of CPU cores 204 is allocated to one batch process, but the system does not depend on the number of physical CPU cores and processing multiplicity (number of CPU cores 204) can be freely set for each node 201. Even when plural threads such as multi-threads or hyper-threads are used, processing multiplicity can also be freely set depending on the situation.

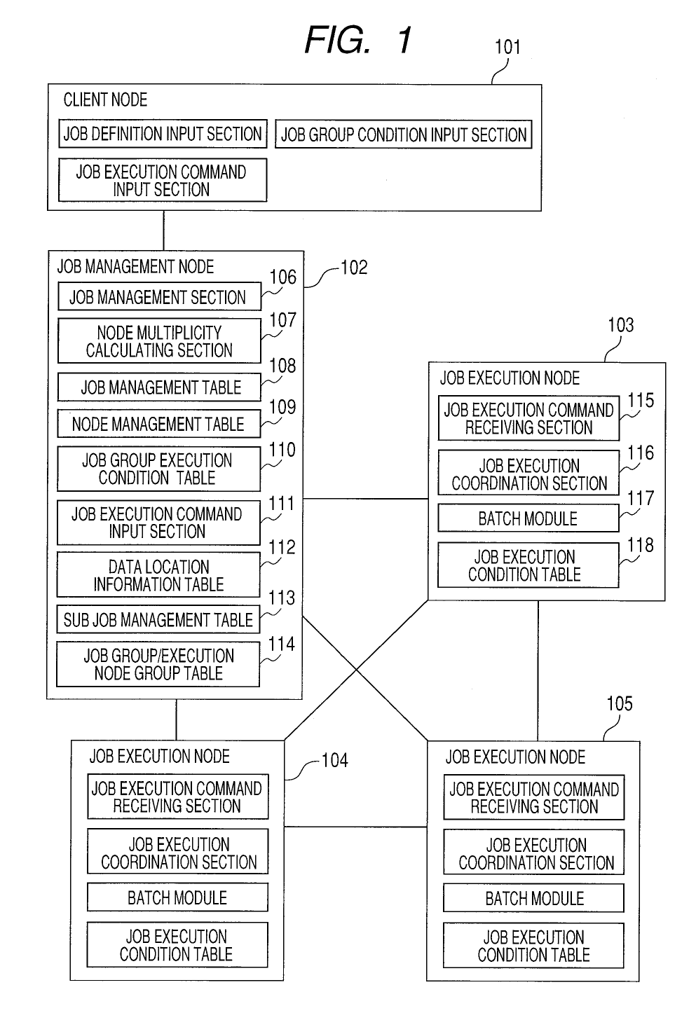

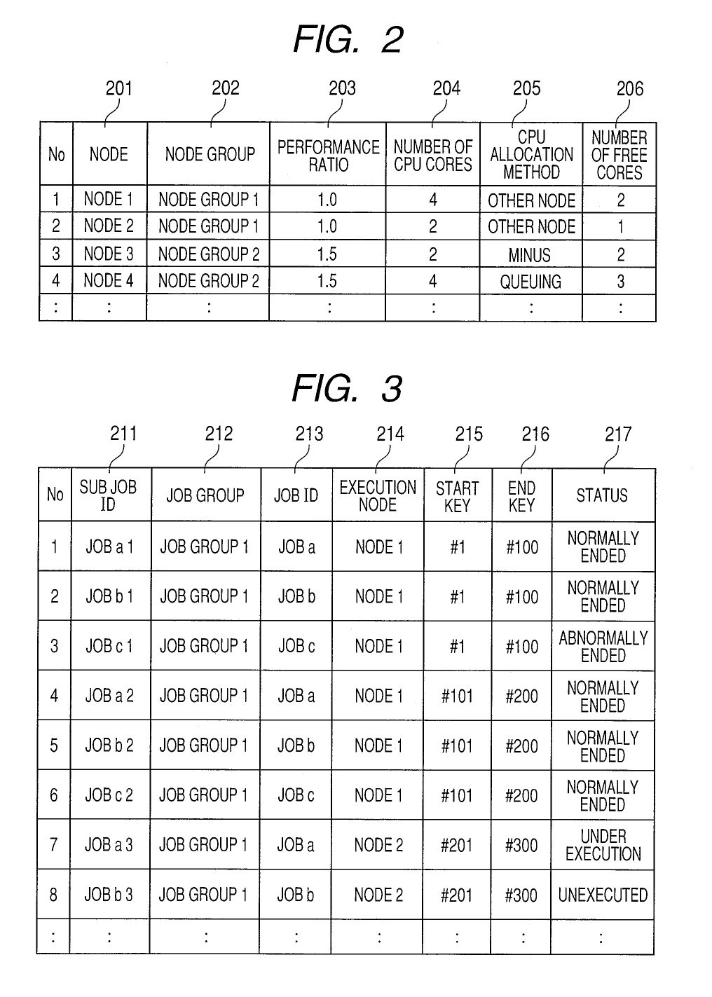

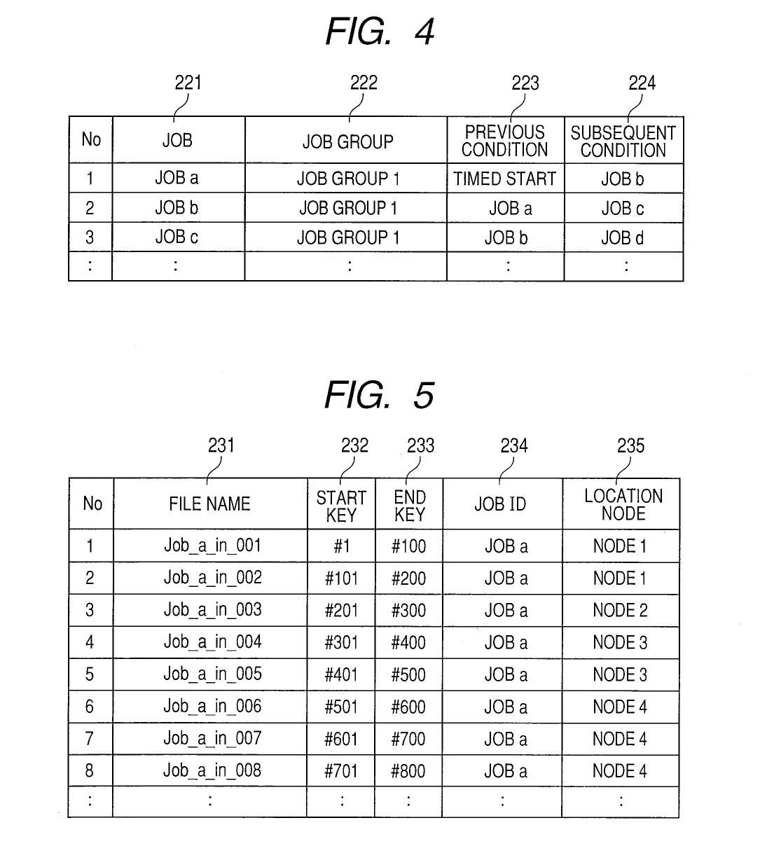

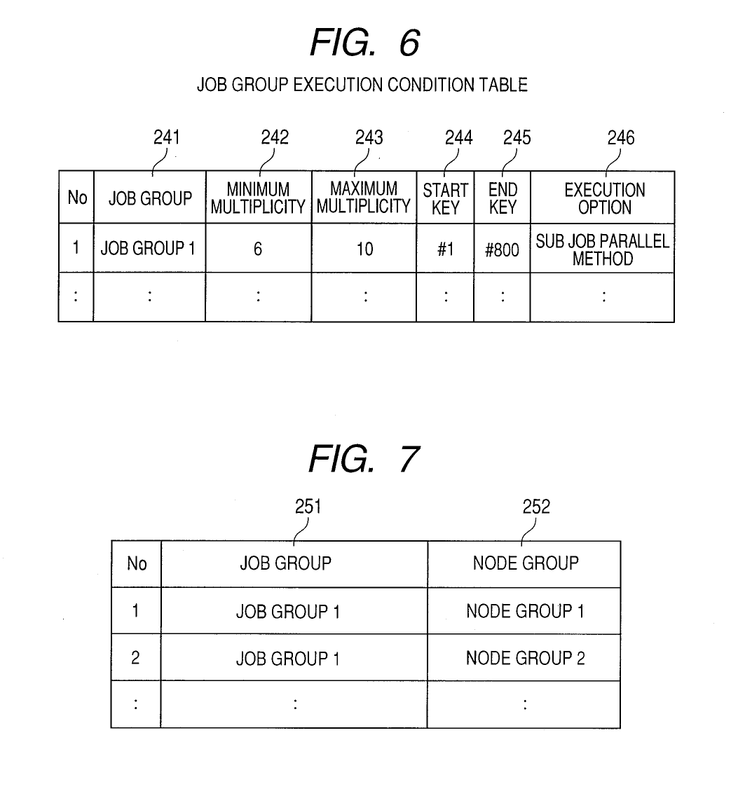

FIG. 1 shows a system configuration according to the preferred embodiment of the invention. This system includes a client node 101, a job management node 102, and job execution nodes 103 to 105. These components are interconnected in a way that they can communicate with each other. The user can access the system through the client node 101 to set parameters. Specifically, the user can set minimum multiplicity 242, maximum multiplicity 243, a start key 244 and an end key 245 for object data to be processed, and an execution option 246 for a job group execution condition table 110. Here, it does not matter what kind of means the user uses to set these parameters through the client node 101.

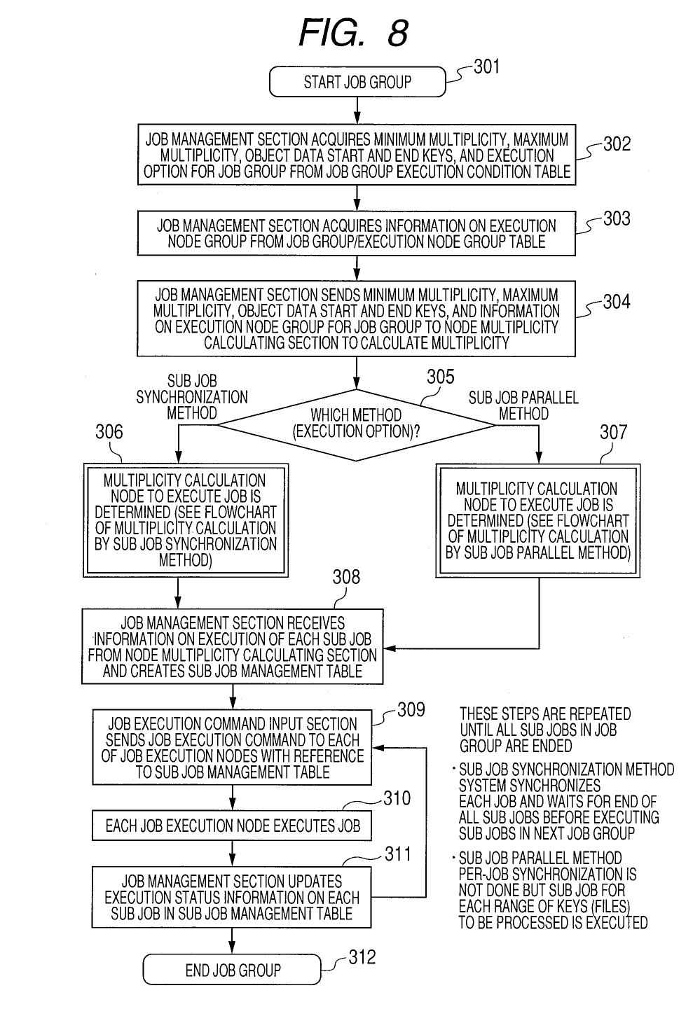

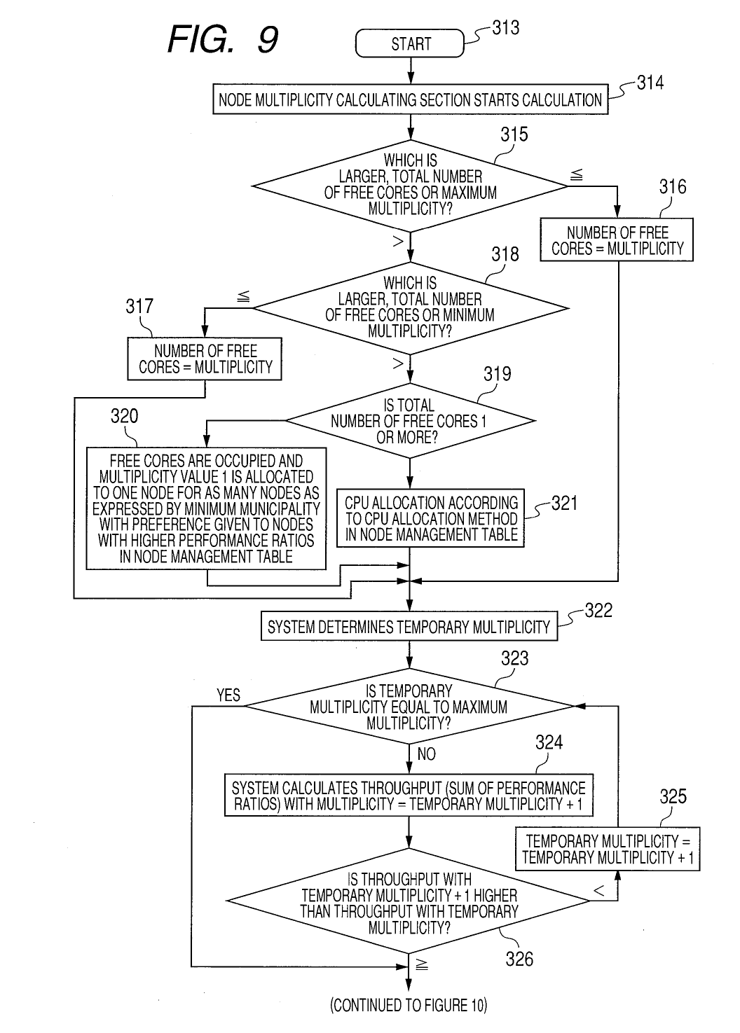

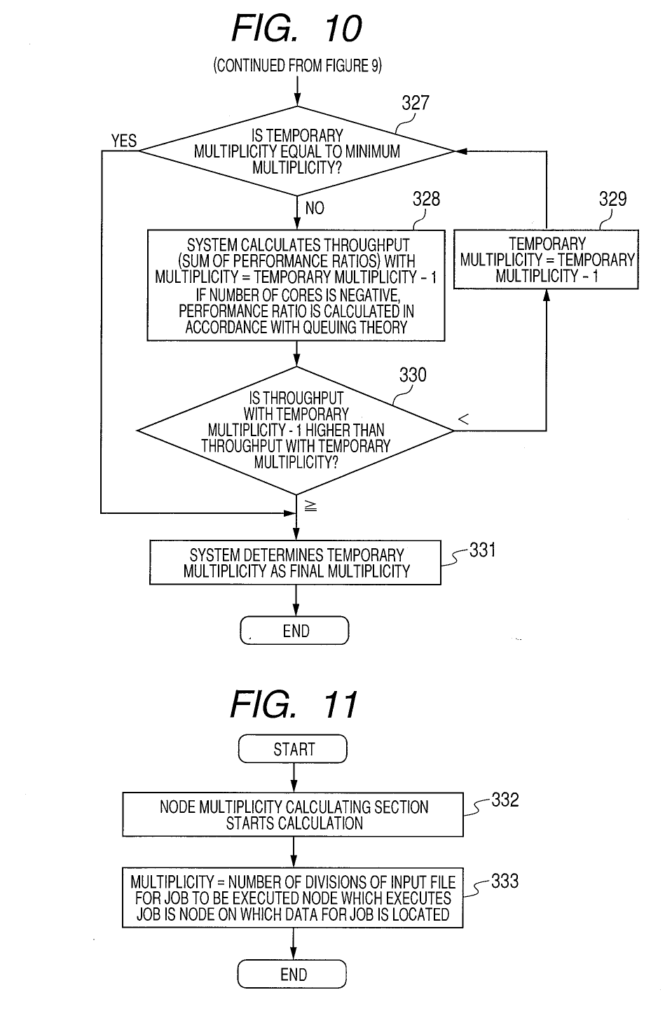

Next, the flow of processing steps in this embodiment will be described referring to the flowcharts (FIGS. 8 to 11).

First, prior to starting job execution, parameter values have been entered for a node management table 109, a job management table 108, a data location information table 112, job group execution condition table 110, and a job group/execution node group table 114 on the job management node 102. Here, the type, entry method and location of parameters do not matter.

When a job group start condition (for example, timed start) is met, a job management section 106 starts a job group (Step 301). Job group start conditions here are the same as conventional job start conditions and there are various types of job start conditions: for example, timed start, log/event monitoring, preceding job, file creation, and manual function. In this embodiment, it does not matter what type of start condition is adopted.

As a start condition is met and the job group is started, the job management section 106 of the job management node 102 acquires the minimum multiplicity 242, maximum multiplicity 243, object data start key 244 and end key 245 for object data to be processed, and execution option 246 for the job group from the job group execution condition table 110 (Step 302).

Next, the job management section 106 acquires information on the node group 252 corresponding to the started job group 251 from the job group/execution node group table 114 (Step 303).

Next, the job management section 106 sends the minimum multiplicity 242, maximum multiplicity 243, object data start key 244 and end key 245 for object data to be processed for the job group, and information on the execution node group 252 to a node multiplicity calculating section 107, and the node multiplicity calculating section 107 calculates multiplicity in job execution (Step 304). According to the execution option 246 sent by the job management section 106, the node multiplicity calculating section 107 decides whether the multiplicity for the job group is determined by the sub job synchronization method or sub job parallel method (Step 305).

Next, how multiplicity in job execution is determined in the sub job synchronization method and the sub job parallel method will be explained.

First, the process of determining multiplicity by the sub job synchronization method is explained. In this method, processing multiplicity is determined depending on the workload on the CPU of each of the job execution nodes 103 to 105 in order to optimize multiplicity in execution of jobs. In this method, temporary multiplicity is first determined and then final multiplicity is determined based on the temporary multiplicity. Temporary multiplicity is multiplicity with which the largest number of cores among free cores are occupied (used), provided that it is within the range between minimum multiplicity 242 and maximum multiplicity 243 in the job group execution condition table 110. In calculating final multiplicity based on the temporary multiplicity, the performances of the job execution nodes 103 to 105 are taken into consideration for the most effective use of the CPU resources. The determination of temporary multiplicity before the determination of final multiplicity makes it possible to find optimum multiplicity without calculating processing performances with different multiplicities, leading to reduction in multiplicity calculation time.

As the node multiplicity calculating section 107 of the job management node 102 starts calculation (Step 314), comparison is made between maximum multiplicity 243 in the job group execution condition table 110 and the total number of free cores 206 in the node management table 109 (Step 315). As a result of comparison, if it is found that the total number of free cores 206 is not smaller than maximum multiplicity 243, as many free cores as expressed by the maximum multiplicity are occupied with preference given to nodes with higher performance ratios in the node management table 109. In this case, the total number of free cores 206 is taken as temporary multiplicity (Step 316).

If the maximum multiplicity 243 is larger than the total number of free cores 206, comparison is made between minimum multiplicity 242 in the job group execution condition table 110 and the total number of free cores 206 in the node management table 109 (Step 318). As a result of comparison, if it is found that the minimum multiplicity 242 is not larger than the total number of free cores 206, the free cores are occupied and the number of free cores 206 is taken as temporary multiplicity (Step 317). If the minimum multiplicity 242 is larger than the total number of free cores 206, the free cores 206 are occupied, provided that multiplicity value 1 is allocated to one node for as many nodes as expressed by the minimum multiplicity with preference given to nodes with higher performance ratios in the node management table 201 (Step 320). In this case, the value of temporary multiplicity is equal to the value of minimum multiplicity.

If the number of free cores is zero, the node multiplicity calculating section 107 allocates CPUs in accordance with the CPU allocation method selected for each node in the node management table 201 (Step 321). If “OTHER NODE” is selected for the CPU allocation method, allocation is made to other nodes (Step 321). If “QUEUING” is selected for the CPU allocation method, the system waits until the number of free cores becomes 1 or more (Step 320). In this case, without affecting the execution of jobs occupying the CPUs at that time, the system waits until a preceding job releases a CPU and the CPU becomes free.

At this stage, the node multiplicity calculating section 107 determines temporary multiplicity (Step 322). Once the temporary multiplicity has been determined, the node multiplicity calculating section 107 starts processing to determine (final) multiplicity based on the temporary multiplicity.

First, the system decides whether the temporary multiplicity is equal to maximum multiplicity 243 (Step 323). If the temporary multiplicity is not equal to the maximum multiplicity 243, throughput is calculated using temporary multiplicity+1 as multiplicity (Step 325). This throughput is an index representing the processing performance of each node as calculated from a performance ratio 203 and the number of CPU cores 204 in the node management table 201. A job is processed by a higher-throughput node in a shorter time than by a lower-throughput node.

If the total number of free cores is smaller than the number of jobs, the number of free cores/the number of jobs is calculated and the calculation result is taken as throughput (Step 324).

After throughput calculation, comparison is made between throughput with temporary multiplicity and throughput with temporary multiplicity+1 (Step 326). If throughput with temporary multiplicity+1 is higher, using temporary multiplicity+1 as temporary multiplicity and again the system decides whether the temporary multiplicity is equal to the maximum multiplicity (Step 323). By repeating these steps, the system determines to which level below the maximum multiplicity the value of temporary multiplicity should be increased.

Using a similar algorithm, the system determines to which level above the minimum multiplicity the value of temporary multiplicity should be decreased. In this case, comparison is made between throughput with temporary multiplicity and throughput with temporary multiplicity−1 (Step 330). If throughput with temporary multiplicity−1 is higher, temporary multiplicity−1 (temporary multiplicity minus 1) is taken as temporary multiplicity (Step 329).

By adjusting the value of temporary multiplicity in accordance with the above algorithm, multiplicity corresponding to the highest throughput is calculated and determined as (final) multiplicity (Step 331). Here, multiplicity corresponding to the “second highest” throughput may be chosen instead of multiplicity corresponding to the “highest” throughput.

After multiplicity has been determined as mentioned above, the node multiplicity calculating section 107 sends multiplicity information to the job management section 106.

Thus, the sub job synchronization method provides a system in which processing multiplicity is calculated depending on how the job execution nodes 103 to 105 are being used, so that jobs are executed with optimum multiplicity.

Next, the process of determining multiplicity by the sub job parallel method is explained. This method provides a system which recognizes a node in which an input file for a job is located and executes the job on that node to minimize communication workload. Here, it does not matter how and where the input file is located.

As the node multiplicity calculating section 107 starts multiplicity calculation in accordance with the sub job parallel method, the system refers to a data location information table 112 and acquires the number of divisions of the input file for the job to be executed (Step 332). This number of divisions is the multiplicity for the job to be executed (Step 333). Here, the node which executes a job should be the node on which the data to be processed for the job is located. For example, on a node in which key #1 to #100 files are located, the job for processing the key #1 to #100 files is executed.

In the sub job parallel method, on a node in which a file to be processed is located, a job for processing the file is executed. This eliminates the need for processing a file located in another node, reducing the communication workload in job execution.

Once multiplicity has been determined, the job management section 106 acquires information on execution of each sub job from the node multiplicity calculating section 107 and creates a sub job management table 113 (Step 308).

The job execution command input section 111 of the job management node 102 sends a job execution command to the job execution nodes 103 to 105 with reference to the sub job management table 202 (Step 309). As the job execution nodes 103 to 105 receive the execution command, they execute jobs in accordance with the received job execution command (Step 310).

After the jobs have been executed, the job management section 106 updates execution status information on each sub job in the sub job management table 202 (Step 311).

What is claimed is:

1. A batch job multiplex processing method which determines multiplicity in execution of a batch job using a plurality of distributed nodes, comprising the steps of:
receiving, from a user, choice of a node group to execute each job group constituting the batch job;
detecting status of nodes constituting the chosen node group or input file status of the batch job;
determining, based on the detected status of the nodes or the detected input file status of the batch job, execution multiplicity expressing the number of nodes constituting the node group to process the batch job;
choosing as many nodes as expressed by the determined execution multiplicity from the node group; and
performing multiplex processing of the batch job on the chosen nodes.

2. The batch job multiplex processing method according to claim 1, wherein the status of the nodes refers to performances and workloads of the nodes.

3. The batch job multiplex processing method according to claim 2, wherein a multiplicity determination method chosen by the user is used for determination of the execution multiplicity.

4. The batch job multiplex processing method according to claim 3,
wherein the user chooses, as the multiplicity determination method, one of a sub job synchronization method in which optimum multiplicity is calculated from the performances and workloads of the nodes and a sub job parallel method in which optimum multiplicity is determined from a location of a file for the batch job; and
wherein execution multiplicity is determined in accordance with the chosen multiplicity determination method.

5. The batch job multiplex processing method according to claim 4, wherein when the sub job synchronization method is chosen, temporary multiplicity is assumed for the determination of execution multiplicity and multiplicity is determined based on the assumed temporary multiplicity.

6. The batch job multiplex processing method according to claim 4, wherein in the sub job parallel method, a value of multiplicity is equal to the number of divisions of an input file and a job for processing the input file is executed on a node in which the input file is located.

7. The batch job multiplex processing method according to claim 5,
wherein the temporary multiplicity is determined by comparing the number of free CPU cores in the node group with minimum multiplicity and maximum multiplicity included in execution conditions of the job group; and
wherein the multiplicity is determined by adjusting a value of the temporary multiplicity and calculating throughputs based on processing performances of the nodes.

8. A batch job multiplex processing system comprising:
a client node which receives a command from a user;
a plurality of distributed nodes; and
a job management node which is connected with the client node and the nodes and determines multiplicity in execution of a batch job using the nodes,
the job management node including:
means for receiving, from the client node, choice of a node group to execute each job group constituting the batch job;
means for detecting status of nodes constituting the chosen node group or input file status of the batch job;
means for determining, based on the detected status of the nodes or the detected input file status of the batch job, execution multiplicity expressing the number of nodes constituting the node group which processes the batch job;
means for choosing as many nodes as expressed by the determined execution multiplicity from the node group; and
means for performing multiplex-processing of the batch job on the chosen nodes.

9. A batch job multiplex processing method which determines multiplicity in execution of a batch job using a plurality of distributed nodes, comprising the steps of:
receiving, from a user, choice of a node group to execute each job group constituting the batch job;
detecting status of nodes constituting the chosen node group or input file status of the batch job;
when determining, based on the detected status of the nodes or the detected input file status of the batch job, execution multiplicity expressing the number of nodes constituting the node group which processes the batch job, determining temporary multiplicity by comparing the number of free CPU cores in the node group with minimum multiplicity and maximum multiplicity included in execution conditions of the job group and determining the execution multiplicity by adjusting a value of the temporary multiplicity and calculating throughputs based on processing performances of the nodes;
choosing as many nodes as expressed by the determined execution multiplicity from the node group; and
performing multiplex processing of the batch job on the chosen nodes.

10. The batch job multiplex processing system according to claim 8, wherein the status of the nodes refers to performances and workloads of the nodes.

11. The batch job multiplex processing system according to claim 10, wherein a multiplicity determination method chosen by the user is used for determination of the execution multiplicity.

12. The batch job multiplex processing system according to claim 11,
wherein the user chooses, as the multiplicity determination method, one of a sub job synchronization method in which optimum multiplicity is calculated from the performances and workloads of the nodes and a sub job parallel method in which optimum multiplicity is determined from a location of a file for the batch job; and
wherein execution multiplicity is determined in accordance with the chosen multiplicity determination method.

13. The batch job multiplex processing system according to claim 12, wherein when the sub job synchronization method is chosen, temporary multiplicity is assumed for the determination of execution multiplicity and multiplicity is determined based on the assumed temporary multiplicity.

14. The batch job multiplex processing system according to claim 12, wherein in the sub job parallel method, a value of multiplicity is equal to the number of divisions of an input file and a job for processing the input file is executed on a node in which the input file is located.

15. The batch job multiplex processing system according to claim 13,
wherein the temporary multiplicity is determined by comparing the number of free CPU cores in the node group with minimum multiplicity and maximum multiplicity included in execution conditions of the job group; and
wherein the multiplicity is determined by adjusting a value of the temporary multiplicity and calculating throughputs based on processing performances of the nodes.
